(19) United States
(12) Patent Application Publication
(10) Pub. No.: US 2008/0029035 A1
(43) Pub. Date: Feb. 7, 2008

(54) Solar powered bird feeder

(76) Inventor: Jun Gou, Guangzhou City (CN)

Correspondence Address: SHAWN HUNTER, P.O Box 270110, HOUSTON, TX, 77277-0110, US

(21) Appl. No.: 11/890,128

(22) Filed: Aug. 2, 2007

Related U.S. Application Data
(60) Provisional application No. 60/834,955, filed on Aug. 2, 2006.

(51) Int. Cl. A01K 39/014; B60K 16/00; F21V 33/00

(52) U.S. Cl. 119/52.2; 362/253; 60/641.8

(57) ABSTRACT

A bird feeder having an LED lighting system that is powered by solar energy. The bird feeder may also include an active cover plate with a pair of transparent light diffusers to diffuse light into the food reservoir of the feeder and below the feeder.

This application claims the priority of U.S. Provisional patent application Ser. No. 60/834,955 filed Aug. 2, 2006.

### BACKGROUND OF THE INVENTION

1. Field of the Invention

The present invention relates to bird feeders. In particular, the present invention relates to bird feeders with solar powered lighting systems.

2. Description of Related Art

Solar energy systems that collect energy and convert it into electrical energy have been known for many years. Only in recent years have these solar energy systems been developed to allow their widespread use in electrical household or outdoor devices.

### SUMMARY OF THE INVENTION

The present invention provides solar powered bird feeders. In preferred embodiments, bird feeders are described having a solar powered lighting system, including a rechargeable electrical power source that can be recharged by the solar energy system; light-emitting diodes (“LEDs”) and a bird feeder having a particular configuration. In one embodiment, a solar energy system is carried by a canopy portion of the feeder, while an LED lighting subsystem is carried by the bird feeder and is electrically coupled to said rechargeable electrical power source for receiving electrical energy daytime and for auto turn on by the photosensor to illuminate the bird feeder at night from a position below a portion of said food reservoir, so that the bird feeder is visible like a lantern at night.

In a particular embodiment of the invention, a solar powered bird feeder is described which includes a diffuser for diffusing light into the food reservoir. In a currently preferred embodiment, the diffuser is a cone shaped element. Also in a preferred embodiment, the feeder has an active cover panel that carries a transparent dome for diffusing light from a lighting element below the feeder and windows within the perch for illuminating portions of the perch by lighting elements. The structure and arrangement of lighting elements and other components provides an unexpectedly pleasing appearance.

### BRIEF DESCRIPTION OF THE DRAWINGS

For a thorough understanding of the present invention, reference is made to the following detailed-description of the preferred embodiments, taken in conjunction with the accompanying drawings in which reference characters designate like or similar elements throughout the several figures of the drawings:

FIG. 1 is an isometric external view of a square shape solar powered bird feeder constructed in accordance with the present invention.

FIG. 2 is a further isometric view of the bird feeder shown in FIG. 1.

FIG. 3 is an exploded view of the bird feeder shown in FIGS. 1 and 2.

FIGS. 4a and 4b are isometric external views of a generally cylindrically shaped solar powered bird feeder constructed in accordance with the present invention.

FIG. 5 is a front view and part cross-sectional view of the solar power bird feeder.

FIG. 6 is a cut-away detail view of a portion of the bird feeder shown in FIG. 5.

FIGS. 7A and 7B depict a further embodiment for a bird feeder constructed in accordance with the present invention.

FIG. 8 is a front, exterior view of a further embodiment for a bird feeder constructed in accordance with the present invention.

FIG. 9 is a cross-sectional cut-away of the bird feeder depicted in FIG. 8.

FIG. 10 is a cut-away detail view of a portion of the bird feeder shown in FIGS. 8 and 9.

### DETAILED DESCRIPTION OF THE PREFERRED EMBODIMENTS

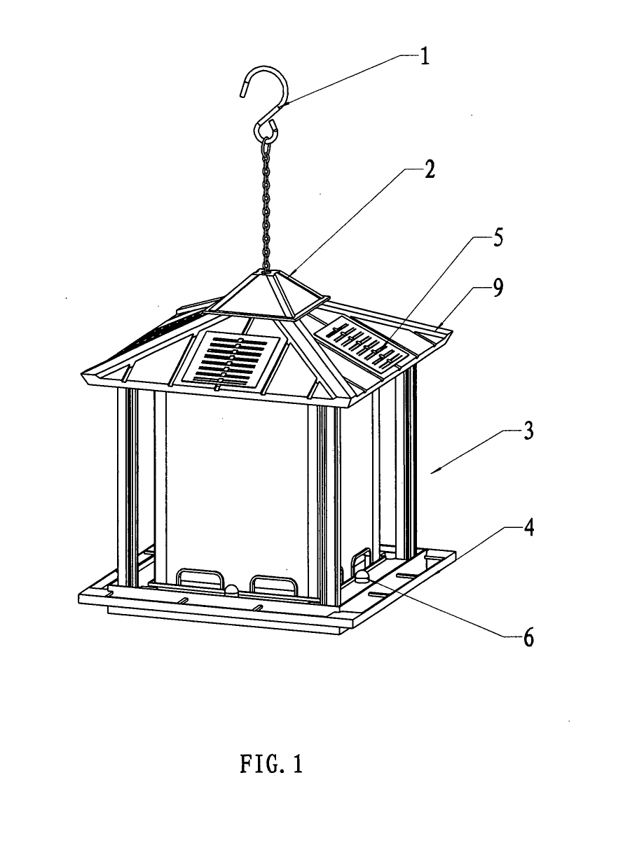

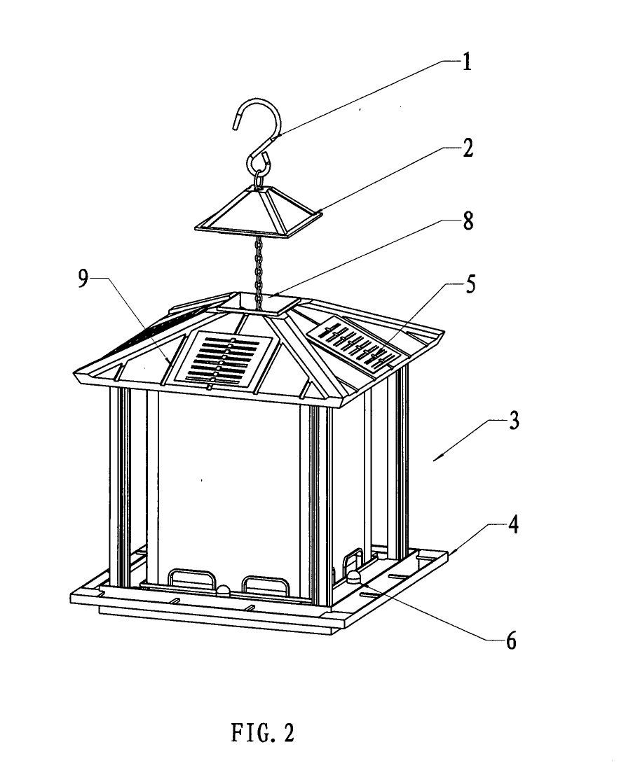

The present invention will be described herein with reference to bird feeders with solar powered lighting systems. Referring to FIGS. 1-6 in the drawings, bird feeder has a hanging means 1, a feeding canopy 2, a food reservoir 3, a perch 4, a solar energy conversion system 5, lighting system 6 and an active cover board 7, etc.

The hanging means 1 may be a hooked cable and may further include a pole which aids in hanging and supporting the weight also couple to connect the feeding canopy 2 and food reservoir 3. Food feeding opening 8 is located in the middle of the food reservoir canopy 9 above the food reservoir 3, which is convenient for opening up the feeding canopy 2 and sliding it along the hanging means 1. The bird food can flow into the food reservoir 3 through the opening 8 in the feeding canopy 2. After filling, the feeding canopy 9 can be slid downward along the hanging means 1 to cover the food feeding opening 8 to protect the bird food in the food reservoir 3 from the weather.

Referring to FIGS. 1-4, the food reservoir 3 includes the food reservoir canopy 9, a mid-joint 10, a reservoir body 11, and a perch 4 which are releasably connected together by connecting poles 12. The advantage of this structure is to be able to ship the components unassembled, thereby making the packaging smaller and saving freight. The reservoir body 11 of the food reservoir 3 is preferably composed of four transparent boards 11a. The upper edges of the transparent boards 11a are inserted into slots in the mid-joint 10, and lower edges of each board 11a are coupled to the grooves in the perch 4. Both ends of the connecting pole 12 are provided with end portions which, upon assembly, reside within complimentary openings 13 within the mid-joint 10 and the perch 4, and smaller alignment holes 14. The connecting poles 12 will support the structural loading of the bird feeder.

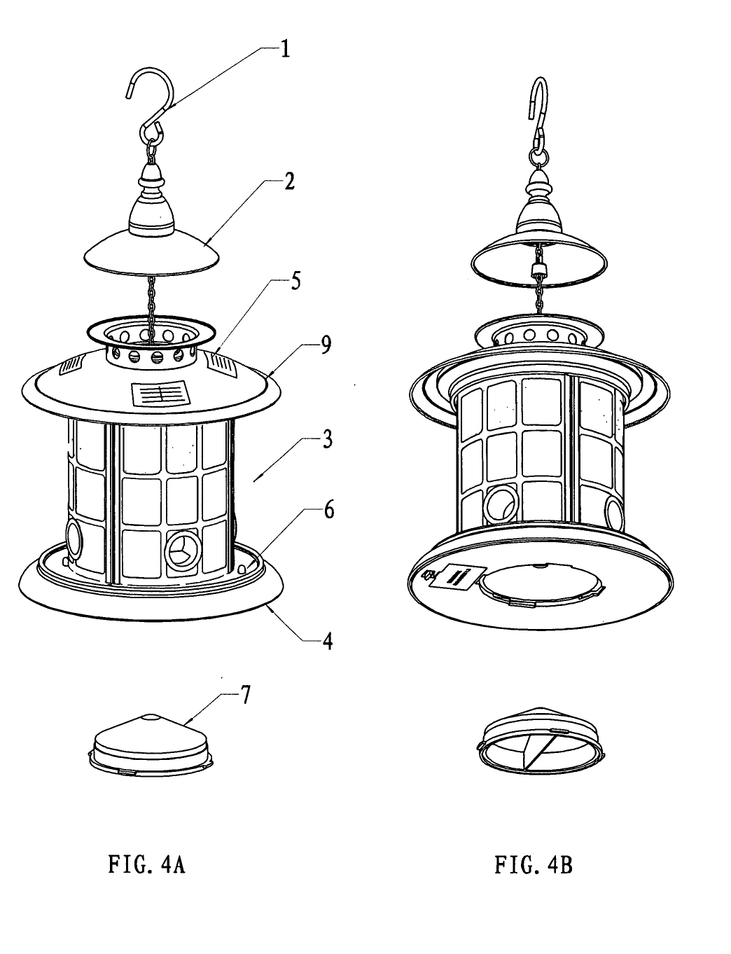

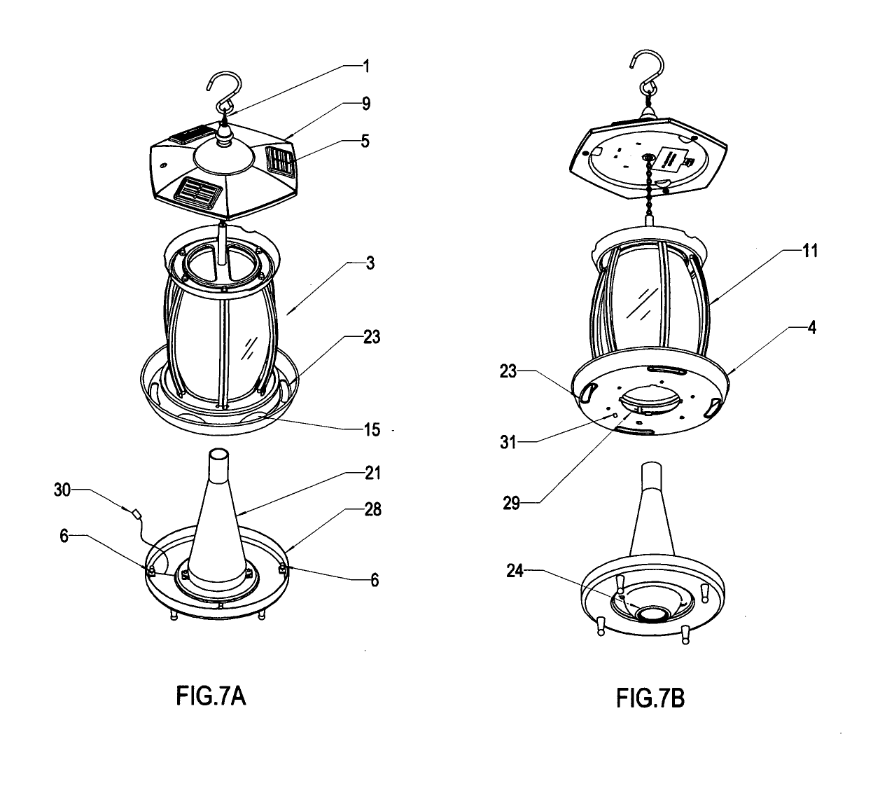

The reservoir body 11 may be integrally combined into one or more component parts releasably connecting together or flex combination, the shape depending on product design, it can be square or round or polygon, etc. Examples of alternative feeder shapes are shown in FIGS. 4A and 4B (cylindrical) and FIGS. 7A, 7B, 8 and 9 (convex cylinder). And the reservoir body 11 is preferably made of suitable material that is treated or finished to prevent rust and wear. Additionally, the reservoir body 11 may include embossed figurines or cut-out shapes that enhance the appearance or motif of the bird feeder.

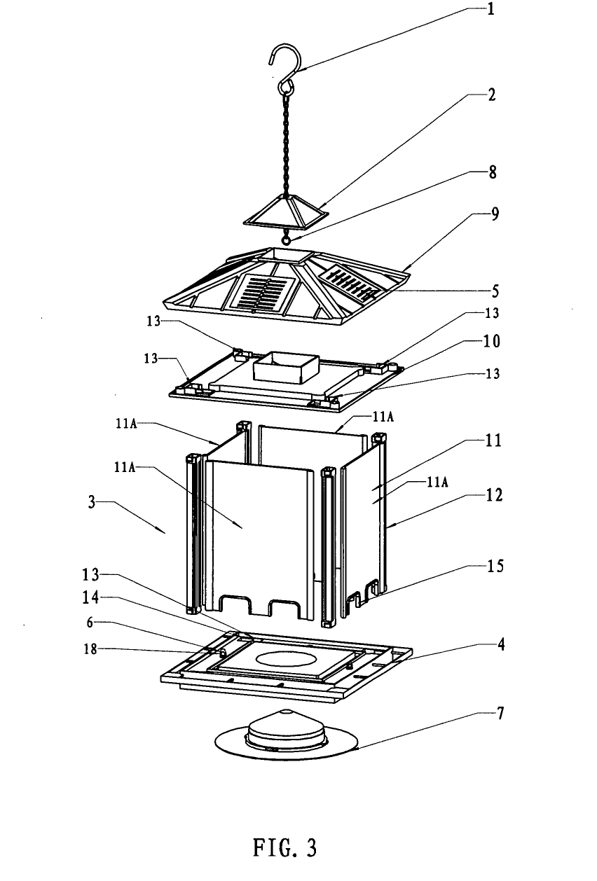

It should be understood that the said connecting poles 12 may also be formed of one of a variety of hard or flexible component parts which is able to combine the food reservoir canopy 9, reservoir 11, perch 4 to into a whole. The reservoir body 11 can also have the same function as connecting poles 12 when it is designed to be able to connect the food reservoir canopy 9, mid-joint 10, and perch 4. The feeding canopy 2 can also be combined into one with the food reservoir canopy 9 to be the top part of the bird feeder. The mid-joint 10, reservoir body 11 and perch 4 compose the lower portion of the feeder. In this instance, one need only to lift up the food reservoir canopy 9 along the hanging means 1, so that bird food can fill the reservoir 11 from the middle holes of the mid-joint 10. At least one outlet port 15 is provided on the solar bird feeder, the position can be at the lower end of the reservoir body 11 (FIG. 3) or beneath the perch 4 (FIGS. 7A, 7B, 8 and 9).

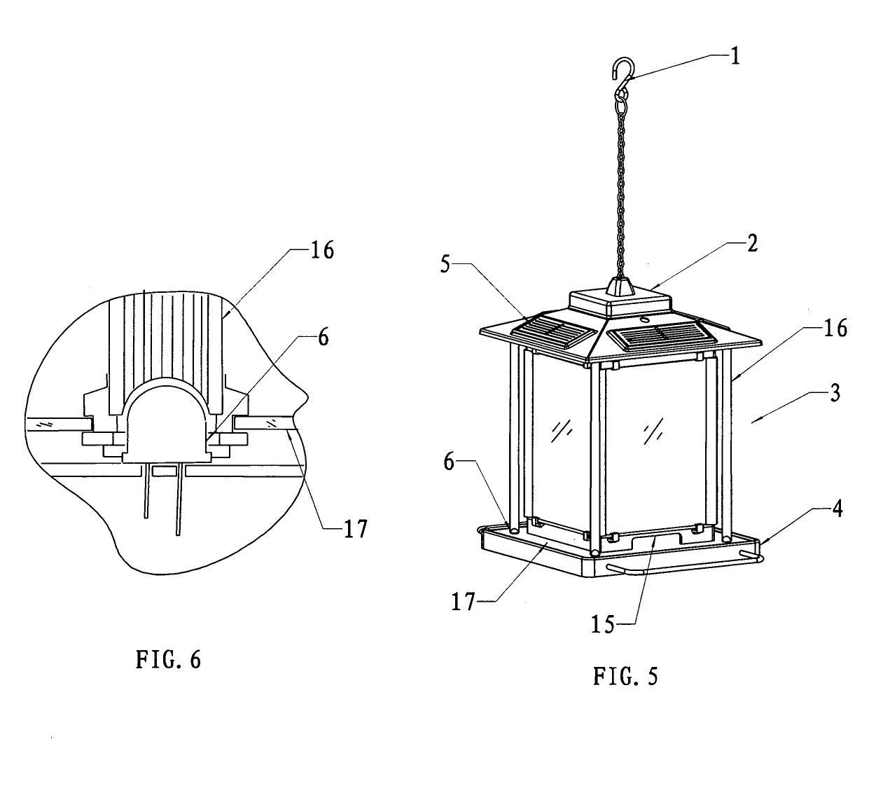

The perch 4 is for birds to stand and gather food from the food outlet ports 15. The perch 4 can be combined into the reservoir body 11. The perch 4 can also be a frame extending from the base of the food reservoir 3 (see FIG. 5), as this is will attract the birds to come and eat. There is an active cover potion 7 in the middle of the perch 4 to open and clean the solar bird feeder when the food access port 8 is not big enough.

A conical projection is preferably provided on the active cover potion 7 to help distribute the bird food in a relatively even manner to each outlet port 15. When the feeding hole 8 is designed big enough to be convenient for cleaning the reservoir 3, there is no need to open the active lower potion 7.

The bird feeder includes a solar energy collection and conversion system to collect solar energy and provide it to the lighting elements. The collection and conversion system basically includes a solar collection panel 5 and a storage battery as well as electrical conductors for supplying the collected electrical energy to the lighting elements. It is preferred that the solar energy collection and conversion system have one or more solar panels 5 positioned proximate the upper part of bird feeder so as to easily receive solar light and convert it to electrical energy. In a preferred embodiment, the solar panels 5 are disposed on the upper surface of the food reservoir canopy 9 and conductively coupled to the lighting system elements 6 to provide electrical energy. A storage battery (not shown), of a type known in the art, is operably associated with the solar panels 5 to store electrical energy collected from the solar panels 5. An optional photosensor (not shown) can be disposed on the food reservoir canopy 9 and conductively coupled to solar energy collection and conversion system to cause the lighting elements 6 to go on at night and off in the daytime.

At least one LED lighting element or multiple LED lighting elements are carried by said bird feeder, disposed at perch 4, for illuminating said reservoir body 11 from a position not higher the bottom of reservoir body 11. The LED lighting system 6 may also have other suitable lighting elements 16 positioned near the food reservoir 4 or transparent board 17 on the plane of the perch 4 for illuminating around the reservoir body 11.

Referring now to FIGS. 7A, 7B, 8, 9 and 10, an alternative embodiment for a bird feeder is depicted. In this bird feeder, the active cover board 28 is preferably disc shaped and carries two or more LED lighting elements 6 at the peripheral edge. A further lighting element 6A (see FIG. 9) is carried approximately in the center of the cover board 28. Electrical conductor 30 is used to provide electrical power to the lighting element 6A. The cover board 28 can be reversibly secured to the perch by a complimentary tab and groove arrangement, of a type known in the art, or in other ways known in the art. The active cover board 28 also carries a transparent diffuser cone 21 on the upper side of the cover board so that, when the cover board is affixed to the perch 4, the diffuser cone 21 is inserted into the food reservoir 11. The upper end of the diffuser cone 21 carries a pair of reflectors 19, 20. The reflector 19 is an opaque, electroplated conical reflector which functions in the manner of a mirror. The reflector 20 is a transparent conically-shaped reflector. When the lighting element 6A is illuminated, light is diffused into the ambient area of the food reservoir 11 via the diffuser cone 21 and reflectors 19, 20.

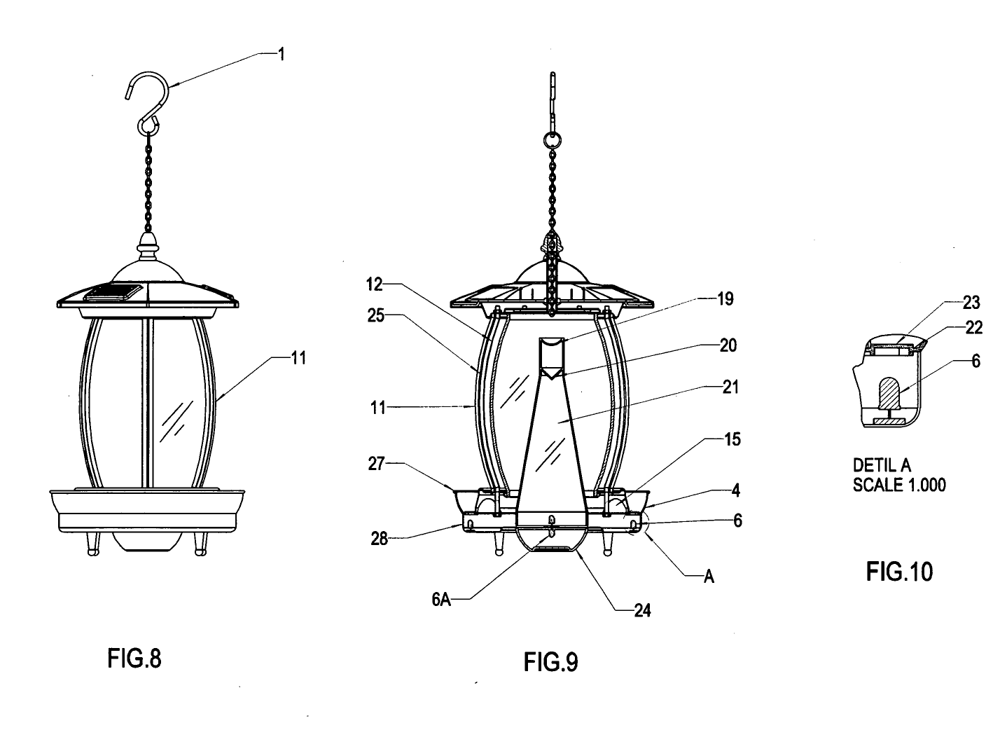

The cover board 28 also carries a transparent, dome-shaped diffuser cover 24. The cover 24 extends below the cover board 28 and acts to diffuse light from the lighting element 6A below the feeder and illuminate the underside of the feeder. It is further noted that the perch 4 is substantially shaped as a trough and is provided with curved openings or windows 23 upon the bottom surface of the trough. When the cover board 28 is affixed to the perch, as shown in FIGS. 8 and 9, the windows 23 will be aligned with the lighting elements 6 (see FIG. 10), and light will illuminate the interior of the perch 4 through the windows 23. It is preferred that the windows 23 be filled with a transparent glass or plastic material to prevent bird food from falling out of the perch 4 when the cover board 28 is removed.

The basic function and structure of the invention has been described above, it is not limited to just above structure and shape, but is amenable to various changes and modifications from the spirit thereof.

1. A bird feeder with solar powered lighting system, comprising:
a hanging means;
a feeding canopy;
a food reservoir having a reservoir body and a bottom;
a perch located proximate the bottom of the food reservoir;
a solar energy collection and conversion system;
an LED lighting element located proximate the perch for illuminating the reservoir from a position not higher than the bottom of the reservoir body; and
the solar energy collection and conversion system disposed on an upper surface of the bird feeder, and conductively coupled to the lighting system to provide electrical energy.

2. The bird feeder according to claim 1, wherein the LED lighting element is positioned proximate lighting elements on the general plane of the perch for illuminating a portion of the reservoir body through diffusion.

3. The bird feeder according to claim 1 further comprising a diffusing element and wherein the LED lighting element illuminates an interior ambient portion of the reservoir body through the diffusing element.

4. The bird feeder according to claim 1, wherein the food reservoir may be integrally combined into one or more component parts releasably connecting together or flex combination.

5. The bird feeder according to claim 1, further comprising: a feeding canopy positioned on top of the food reservoir, which can be lifted up along a hanging means.

6. The bird feeder according to claim 1, further comprising: an active cover board positioned on the bottom of the perch, and a conical element for diffusing the bird food toward openings proximate the perch.

7. The bird feeder according to claim 1 further comprising:
a removable active cover board to be removably affixed to the bottom of the perch, the active cover board containing:
a transparent diffuser element on an upper side of the cover board that is inserted into the reservoir body when the cover board is affixed to the perch;
a transparent cover located on an underside of the cover board; and
a lighting element to provide light to the diffuser and the transparent cover.

8. The bird feeder according to claim 7 wherein the active cover board contains a tab to align with a cutout on the perch for releasably interconnecting the cover board with the perch.

9. The bird feeder according to claim 7 wherein the diffuser element is generally cone-shaped and diffuses light from a lighting element into the reservoir body.

10. The bird feeder according to claim 9 further comprising a reflector contained within the diffuser element proximate an upper end of the diffuser.

10. (canceled)

11. The bird feeder according to claim 7 wherein the lighting element is retained by the cover board between the transparent diffuser element and the transparent cover.

12. The bird feeder of claim 7 further comprising an aperture disposed through a portion of the perch to permit diffused light from the cover to illuminate upper portions of the perch.

13. The bird feeder of claim 12 wherein the aperture is provided with a solid transparent lens to prevent bird food from falling out of the perch.

14. The bird feeder of claim 7 further comprising an electrical conductor that interconnects the lighting element with a solar power source.

15. A bird feeder with solar powered lighting system comprising:
a food reservoir having a reservoir body and a bottom;
a perch located proximate the bottom of the food reservoir;
a solar energy collection and conversion system; and
an LED lighting element operably associated with the solar energy collection and conversion system and located for illuminating the reservoir from a position not higher than the bottom of the reservoir body.

16. The bird feeder of claim 15 further comprising a first transparent diffuser located within the food reservoir to diffuse light from the lighting element within the food reservoir.

17. The bird feeder of claim 16 wherein the first diffuser is substantially conically-shaped.

18. The bird feeder of claim 17 wherein the first diffuser further comprises at least one reflector to help diffuse light within the food reservoir.

19. The bird feeder of claim 15 further comprising a second transparent diffuser located on an underside of the bird feeder to diffuse light from the lighting element below the feeder.

20. The bird feeder of claim 15 wherein the lighting element is located below the perch and wherein the perch is shaped as a trough and provides a bottom surface which includes at least one transparent window for diffusing light from the lighting element into the perch.
